(19) United States
(12) Patent Application Publication
(10) Pub. No.: US 2023/0349047 A1
(43) Pub. Date: Nov. 2, 2023

(54) NANOWIRE-EQUIPPED FILM AND NANOWIRE MANUFACTURING METHOD

(71) Applicant: TORAY ENGINEERING CO., LTD., Tokyo (JP)

(72) Inventors: Munekazu IKEDA, Otsu-shi, Shiga (JP); Hajime HIRATA, Otsu-shi, Shiga (JP)

(21) Appl. No.: 17/791,267

(22) PCT Filed: Dec. 14, 2020
(86) PCT No.: PCT/JP2020/046475

§ 371 Date: Jul. 7, 2022

(30) Foreign Application Priority Data
Jan. 9, 2020 (JP) 2020-001840
Jun. 9, 2020 (JP) 2020-100129

(51) Int. Cl. C23C 18/12; C23C 18/04

(52) U.S. Cl. CPC C23C 18/1216; C23C 18/1266; C23C 18/1233; C23C 18/04; B82Y 30/00

(57) ABSTRACT

A nanowire-equipped film comprises a substrate made of a crystalline resin, and nanowires made of a metal oxide and grown directly on the substrate. A fine textured structure is formed on a surface of the substrate, and the nanowires are grown directly from the textured structure.

### CROSS-REFERENCE TO RELATED APPLICATIONS

This application is a U.S. National stage of International Application No. PCT/JP2020/046475 filed on Dec. 14, 2020. This application claims priority to Japanese Patent Application Nos. 2020-001840 filed on Jan. 9, 2020 and 2020-100129 filed on Jun. 9, 2020 with Japan Patent Office. The entire disclosures of Japanese Patent Application Nos. 2020-001840 and 2020-100129 are hereby incorporated herein by reference.

### BACKGROUND

### Field of the Invention

The present invention relates to a nanowire-equipped film in which nanowires are grown on a substrate, and a method for manufacturing nanowires on a substrate.

### Background Information

Many different methods are known for manufacturing nanowires (nanorods) made of zinc oxide or another such metal oxide, such as chemical vapor deposition, laser deposition, and hydrothermal synthesis.

Of these, the hydrothermal synthesis allows nanowires to be manufactured with relative ease. For example, Japanese Laid-Open Patent Application Publication No. 2011-36995 (Patent Literature 1) discloses a method in which a substrate having a seed layer formed on its surface is immersed in an aqueous solution of zinc nitrate and hexamethylenetetramine to grow zinc oxide nanowires at a temperature of 30° C. to 100° C.

### SUMMARY

With conventional methods for manufacturing nanowires, without exception, it was necessary to form a seed layer for growing nanowires on the substrate in advance. This posed a problem in that the manufacturing cost was higher. Another problem was that impurities in the seed layer were admixed into the nanowires in the course of peeling off and collecting the nanowires grown on the seed layer.

Nevertheless, there has so far been no way to grow nanowires directly, without first forming a seed layer on the substrate. In prior art there has been nothing whatsoever suggested about how to avoid forming more powder layer than necessary, or to improve inefficient operation in the drop-off and squeegeeing of powder.

The present disclosure was conceived in light of the above, and a main object thereof is to provide a nanowire-equipped film in which nanowires are grown directly on a substrate, and a method for manufacturing nanowires in which nanowires are grown directly on a substrate.

The nanowire-equipped film according to the present disclosure comprises a substrate made of a crystalline resin, and nanowires made of a metal oxide grown directly on the substrate, wherein a fine textured structure is formed on the surface of the substrate, and the nanowires are grown directly from the textured structure.

The method for manufacturing nanowires according to the present disclosure includes a step (a) of preparing a substrate made of a crystalline resin, a step (b) of forming a fine textured structure on the surface of the substrate, and a step (c) of immersing the substrate in a hydrothermal synthesis solution to grow nanowires made of a metal oxide directly on the textured structure formed on the surface of the substrate.

The nanowire-equipped film according to the present disclosure comprises a substrate made of an amorphous resin, and nanowires made of a metal oxide grown directly on the substrate, wherein a fine textured structure having a pitch of 2 to 100 nm and a depth of 5 to 30 nm is formed on the surface of the substrate, and the nanowires are grown directly from the textured structure.

The method for manufacturing a nanowire according to the present disclosure includes a step (a) of preparing a substrate made of an amorphous resin, a step (b) of forming a fine textured structure having a pitch of 2 to 100 nm and a depth of 5 to 30 nm on the surface of the substrate, and a step (c) of immersing the substrate in a hydrothermal synthesis solution to grow nanowires made of a metal oxide directly on the textured structure formed on the surface of the substrate.

The present disclosure provides a nanowire-equipped film in which nanowires are grown directly on a substrate, and a method for manufacturing nanowires in which nanowires are grown directly on a substrate.

### BRIEF DESCRIPTION OF THE DRAWINGS

FIGS. 1A and 1B are bright-field scanning transmission electron micrographs of a sample produced by growing nanowires;

FIG. 2A is a graph of the results of elemental analysis by energy dispersive X-ray analysis of a sample produced by growing nanowires;

FIG. 2B is a scanning transmission electron micrograph of a cross section of a sample that has undergone elemental analysis;

FIG. 3 is a scanning transmission electron micrograph of a cross section of a sample produced by growing ZnO nanowires;

FIGS. 4A, 4B, 4C and 4D are step diagrams showing a method for manufacturing ZnO nanowires;

FIG. 5 is a cross-sectional view of a jig for fixing a polyimide film or a polycarbonate film;

FIGS. 6A and 6B are bright-field scanning transmission electron micrographs of a sample produced by growing nanowires; and

FIG. 7 is a scanning transmission electron micrograph of a cross section of a sample produced by growing ZnO nanowires.

### DETAILED DESCRIPTION OF EMBODIMENTS

Part 1

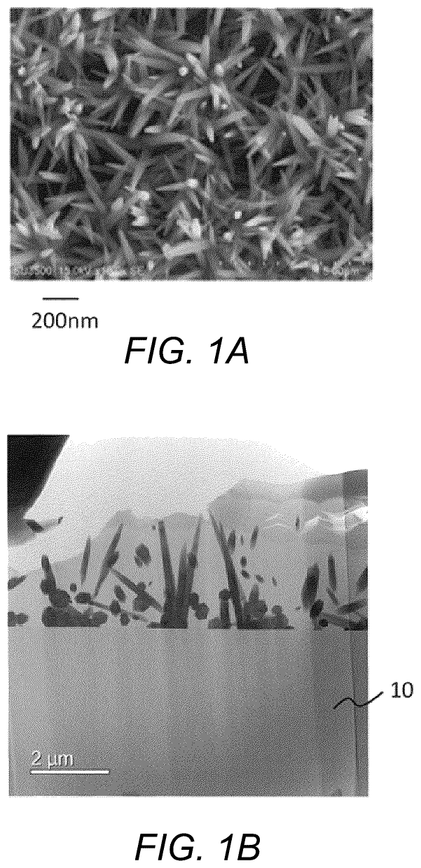

Before describing the present disclosure, the events that led to the conception of the present disclosure will be described. In this Part 1, we will describe a case in which number 10 in FIGS. 1A to 5 is a polyimide film.

The inventors of the present application had developed a technique for using a silicon wafer as a substrate and growing nanowires on this substrate. A seed layer was formed by sputtering chromium onto the surface of the silicon wafer.

However, since silicon wafers are expensive, the inventors examined ways to grow nanowires on a substrate by using a resin film (polyimide) as the substrate, in an effort to reduce the manufacturing cost.

However, since it is difficult to sputter chromium directly onto a resin film to form a seed layer, a silicon oxide film had to be formed on the resin film by sputtering, after which chromium was sputtered onto this silicon oxide film to form a seed layer. This meant that a new step of forming a silicon oxide film had to be added, which did not lead to a reduction in manufacturing cost.

In view of this, the inventors wondered if nanowires could be directly grown on a resin film without first forming a seed layer.

For many years, the inventors researched techniques (surface modification techniques) for imparting a function different from that of the substrate by subjecting a resin film to a surface treatment to modify the surface state. For instance, they developed a technique for improving the adhesion to a film formed on a resin film by subjecting the resin film to a surface treatment.

The inventors turned their attention to this surface modification technique. Specifically, they wondered if it would be possible to utilize a surface modification technique to bring about a seeding property that would allow nanowires to grow on the surface of a resin film. For example, it seemed possible that if the resin film were subjected to a surface treatment to impart some kind of activation to the surface of the resin film, this activated state could become the nucleus of nanowire growth.

In view of this, the inventors conducted an experiment using a polyimide film, which is a crystalline resin material. More specifically, a polyimide film (Capton V, manufactured by Toray DuPont) was subjected to a surface treatment, after which this polyimide film was immersed in an aqueous solution containing a mixture of zinc nitrate (Zn(NO₃)₂/6H₂O) and hexamethylenetetramine (C₆H₁₂N₄) to grow nanowires of zinc oxide (ZnO). A known method was used to grow the nanowires by the hydrothermal synthesis method used herein.

When experiments were conducted under various surface treatment conditions, it was surprisingly discovered that ZnO nanowires grew directly on the surface of the polyimide film that had been surface-treated under certain conditions.

FIGS. 1A and 1B are bright-field scanning transmission electron micrographs (BF-STEM) of a sample produced by growing nanowires, with FIG. 1A being a plan view micrograph, and FIG. 1B a cross-sectional micrograph.

As shown in FIGS. 1A and 1B, it can be confirmed that columnar nanowires have grown on the polyimide film 10.

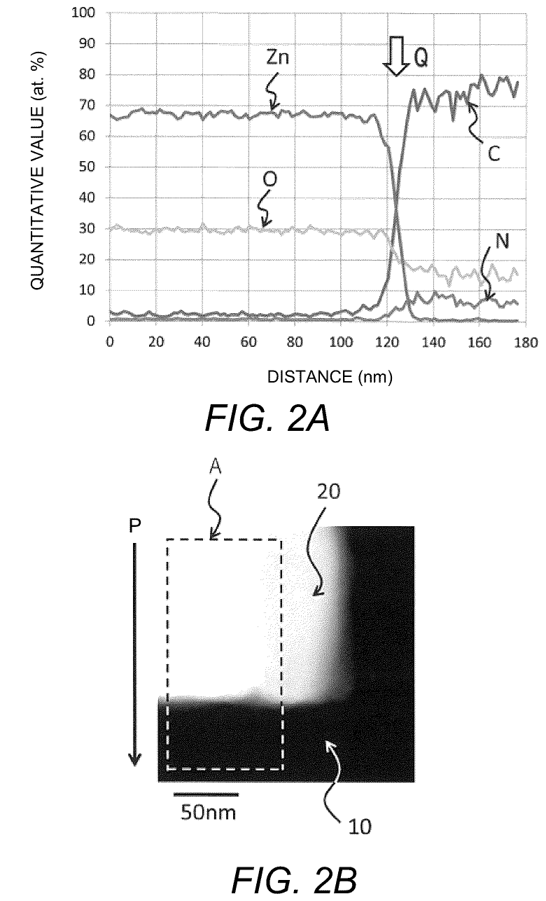

Also, FIG. 2A is a graph of the results of elemental analysis by energy dispersive X-ray analysis (EDX) in the direction of the arrow P in the area A of a cross section of the sample produced by growing nanowires, as shown in FIG. 2B. Here, in FIG. 2B, 10 is a polyimide film, and 20 is a grown nanowire. Also, in FIG. 2A, the position indicated by the arrow Q is the interface between the polyimide film 10 and the nanowire 20.

It can be seen from FIG. 2A that zinc (Zn) and oxygen (O) are present in the region where the nanowire 20 is present. On the other hand, it can be seen that carbon (C) and nitrogen (N) are present in the region where the polyimide film 10 is present. No elements other than these were detected in the vicinity of the interface Q. This analysis result tells us that the ZnO nanowire 20 has grown directly on the polyimide film 10.

Incidentally, although ZnO nanowires grew on the surface-treated polyimide film 10, no ZnO nanowires at all grew on a polyimide film 10 that had not undergone surface treatment, which leads to the following conclusion.

That is, it seems that performing a surface treatment on the polyimide film 10 changes the surface of the polyimide film 10 to a state in which ZnO nanowires can grow.

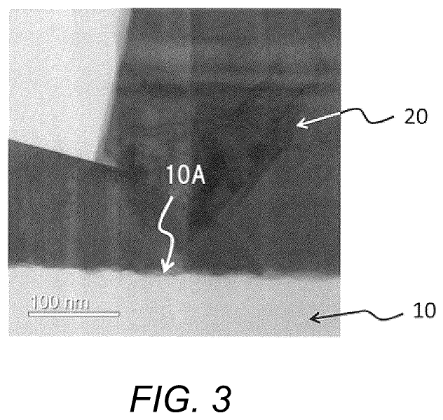

In view of this, in experiments conducted under various surface treatment conditions, a cross section of a sample in which ZnO nanowires grew on the polyimide film 10 was examined in greater detail using a scanning transmission electron microscope. As a result, as shown in FIG. 3, it was found that in the sample in which the ZnO nanowires grew, a fine textured structure 10A had been formed on the surface of the polyimide film 10.

On the other hand, it was found that ZnO nanowires did not grow in the sample in which the fine textured structure 10A was not formed on the surface of the polyimide film 10 even though a surface treatment had been performed.

That is, although the precise mechanism remains unclear, it is believed that the fine textured structure 10A formed on the surface of the polyimide film 10 plays the role of a nucleus for growing nanowires, like a conventional seed layer.

Furthermore, just as the nanowire growth state varies depending on the seed layer formation conditions or the nanowire growth conditions in a conventional seed layer, so too does the nanowire growth state vary depending on the formation conditions of the fine textured structure 10A or the nanowire growth conditions with the fine textured structure 10A of the present disclosure.

Therefore, the shape of the fine textured structure 10A may be suitably determined as dictated by the required specifications of the nanowires, but the nanowires are preferably formed such that the size is a micrometer or less and the depth is on the nanometer level. Typically, the fine textured structure 10A is preferably formed to have a size of 2 to 100 nm and a depth of 5 to 30 nm.

In this embodiment, forming the fine textured structure 10A on the surface of the polyimide film 10 in advance makes it possible to form ZnO nanowires directly on the polyimide film 10.

As described above, the nanowire-equipped film in this embodiment comprises a polyimide film (substrate) 10 made of a crystalline resin, and ZnO nanowires grown directly on the polyimide film 10, wherein the fine textured structure 10A is formed on the surface of the polyimide film 10. Here, the fine textured structure 10A is preferably formed to have a size of a micrometer or less and a depth on the nanometer level. Also, the grain boundary of the polyimide film is preferably deposited on the surface of the polyimide film 10. This allows the ZnO nanowires to be grown stably.

In this embodiment, ZnO nanowires can be grown directly on the polyimide film 10, which is made of a crystalline resin, which reduces the manufacturing cost. Also, since the ZnO nanowires do not contain any impurities caused by diffusion from a conventional seed layer, ZnO nanowires free of impurities can be peeled off and collected.

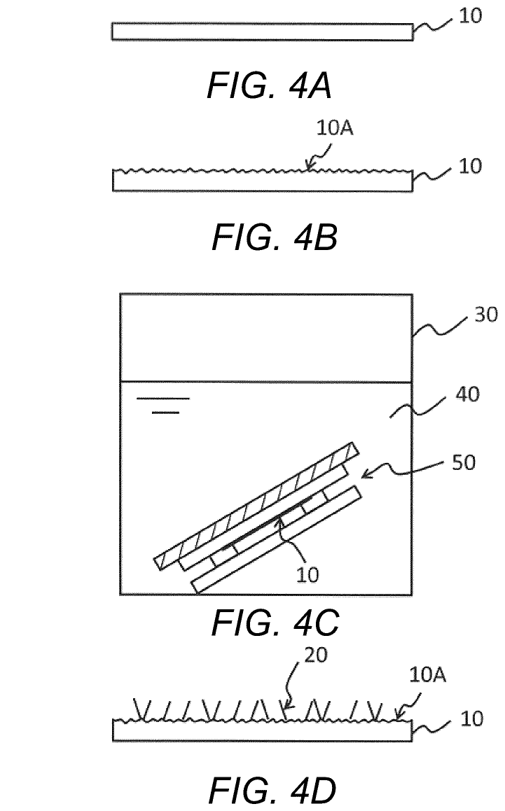

The ZnO nanowires in this embodiment can be manufactured by the steps shown in FIGS. 4A, 4B, 4C and 4D.

First, as shown in FIG. 4A, a polyimide film 10 made of a crystalline resin is prepared. The thickness of the polyimide film 10 is 50 to 500 μm, for example.

Next, as shown in FIG. 4B, the polyimide film 10 is surface-treated. This surface treatment is to be performed under conditions that will form a fine textured structure 10A on the surface of the polyimide film 10. The actual dimensions of the textured structure 10A are not shown in FIG. 4B. Here, the fine textured structure 10A is preferably formed to have a size of a micrometer or less and a depth on the nanometer level.

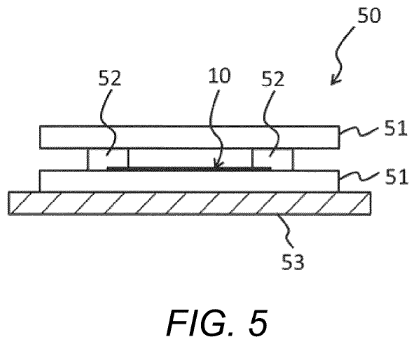

Next, as shown in FIG. 4C, the polyimide film 10 is immersed in a hydrothermal synthesis solution 40 in a container 30, and ZnO nanowires are grown directly on the polyimide film 10. Since the polyimide film 10 is extremely thin, it is preferable to immerse it in the hydrothermal synthesis solution 40 while fixed to a jig 50. More specifically, as shown in FIG. 5, the polyimide film 10 is pressed by pieces of slide glass 52, 52, these pieces of slide glass 52, 52 are sandwiched between glass plates 51, 51 and fixed, and this product is placed on a stainless steel plate 53 and immersed in the hydrothermal synthesis solution 40 in this state.

An aqueous solution containing a mixture of zinc nitrate (Zn(NO₃)₂/6H₂O) and hexamethylenetetramine (C₆H₁₂N₄) can be used for the hydrothermal synthesis solution 40, for example. The concentration of the hydrothermal synthesis solution 40, the mixing ratio, the temperature, the immersion time, and so forth may be suitably determined as dictated by the required specifications of the ZnO nanowires.

After the polyimide film 10 has been immersed in the hydrothermal synthesis solution 40 for a specific length of time, the polyimide film 10 on which the ZnO nanowires have grown is washed and dried to obtain a ZnO nanowire-equipped film 20 as shown in FIG. 4D.

The present disclosure was described above through a preferred embodiment, but what was said above is not intended to be limiting in nature, and various modifications are of course possible.

For example, in the above embodiment, the polyimide film 10 was used as the substrate, and ZnO nanowires were grown on the substrate, but this is not the only option, and any substrate made of a crystalline resin may be used. This crystalline resin can be a polyester or the like, for example.

Also, in the above embodiment, the ZnO nanowires 20 were grown on the polyimide film 10, but this is not the only option, and nanowires made of some other metal oxide such as titanium oxide (TiO) can be grown instead.

Part 2

Before describing the present disclosure, the events that led to the conception of the present disclosure will be described. In this Part 2, we will describe a case in which number 10 in FIGS. 4A to 7 is a polycarbonate film.

The inventors of the present application had developed a technique for using a silicon wafer as a substrate and growing nanowires on this substrate. A seed layer was formed by sputtering chromium onto the surface of the silicon wafer.

However, since silicon wafers are expensive, the inventors examined ways to grow nanowires on a substrate by using a resin film (polycarbonate) as the substrate, in an effort to reduce the manufacturing cost.

However, since it is difficult to sputter chromium directly onto a resin film to form a seed layer, a silicon oxide film had to be formed on the resin film by sputtering, after which chromium was sputtered onto this silicon oxide film to form a seed layer. This meant that a new step of forming a silicon oxide film had to be added, which did not lead to a reduction in manufacturing cost.

In view of this, the inventors wondered if nanowires could be directly grown on a resin film without first forming a seed layer.

For many years, the inventors researched techniques (surface modification techniques) for imparting a function different from that of the substrate by subjecting a resin film to a surface treatment to modify the surface state. For instance, they developed a technique for improving the adhesion to a film formed on a resin film by subjecting the resin film to a surface treatment.

The inventors turned their attention to this surface modification technique. Specifically, they wondered if it would be possible to utilize a surface modification technique to bring about a seeding property that would allow nanowires to grow on the surface of a resin film. For example, it seemed possible that if the resin film were subjected to a surface treatment to impart some kind of activation to the surface of the resin film, this activated state could become the nucleus of nanowire growth.

In view of this, the inventors conducted an experiment using a polycarbonate film, which is an amorphous resin material. More specifically, a polycarbonate film (Carboglass C110C manufactured by Asahi Glass) was subjected to a surface treatment, after which this polycarbonate film was immersed in an aqueous solution containing a mixture of zinc nitrate (Zn(NO₃)₂/6H₂O) and hexamethylenetetramine (C₆H₁₂N₄) to grow nanowires of zinc oxide (ZnO). A known method was used to grow the nanowires by the hydrothermal synthesis method used herein.

When experiments were conducted under various surface treatment conditions, it was surprisingly discovered that ZnO nanowires grew directly on the surface of the polycarbonate film that had been surface-treated under certain conditions.

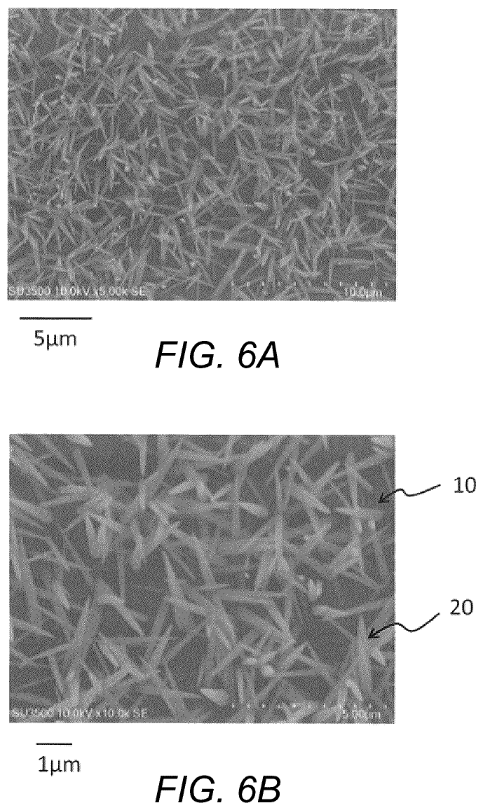

FIGS. 6A and 6B are bright-field scanning transmission electron micrographs (BF-STEM) of a sample produced by growing nanowires. It can be confirmed from FIGS. 6A and 6B that columnar nanowires 20 are grown on the polycarbonate film 10.

Also, elemental analysis of a cross section of a sample in which nanowires were grown, by energy dispersive X-ray analysis (EDX) confirmed that zinc (Zn) and oxygen (O) were present in the region where the nanowires 20 were located. On the other hand, it was confirmed that carbon (C) and nitrogen (N) were present in the region where the polycarbonate film 10 was located. This analysis result tells us that the ZnO nanowires 20 grew directly on the polycarbonate film 10.

Incidentally, although ZnO nanowires grew on the surface-treated polycarbonate film 10, no ZnO nanowires at all grew on a polycarbonate film 10 that had not undergone surface treatment, which leads to the following conclusion.

That is, it seems that performing a surface treatment on the polycarbonate film 10 changes the surface of the polycarbonate film 10 to a state in which ZnO nanowires can grow.

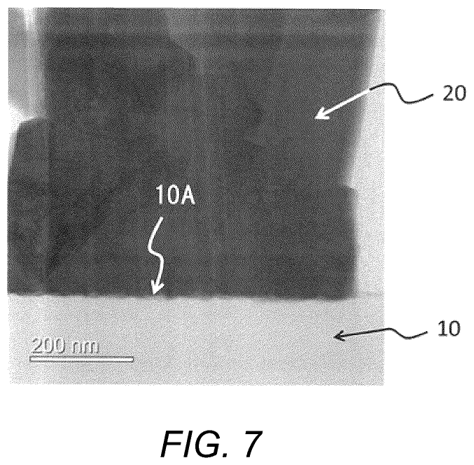

In view of this, in experiments conducted under various surface treatment conditions, a cross section of a sample in which ZnO nanowires grew on the polycarbonate film 10 was examined in greater detail using a scanning transmission electron microscope. As a result, as shown in FIG. 7, it was found that in the sample in which the ZnO nanowires grew, a fine textured structure 10A had been formed on the surface of the polycarbonate film 10.

On the other hand, it was found that ZnO nanowires did not grow in the sample in which the fine textured structure 10A was not formed on the surface of the polycarbonate film 10 even though a surface treatment had been performed.

That is, although the precise mechanism remains unclear, it is believed that the fine textured structure 10A formed on the surface of the polycarbonate film 10 plays the role of a nucleus for growing nanowires, like a conventional seed layer.

Furthermore, just as the nanowire growth state varies depending on the seed layer formation conditions or the nanowire growth conditions in a conventional seed layer, so too does the nanowire growth state vary depending on the formation conditions of the fine textured structure 10A or the nanowire growth conditions with the fine textured structure 10A of the present disclosure.

Therefore, the shape of the fine textured structure 10A may be suitably determined as dictated by the required specifications of the nanowires (density, length, thickness, etc.), but in order to grow the nanowires stably, the fine textured structure 10A is preferably formed such that the pitch (the distance between convex portions (concave portions)) is 2 to 100 nm and the depth is 5 to 30 nm.

In this embodiment, forming the fine textured structure 10A on the surface of the polycarbonate film 10 in advance makes it possible to form ZnO nanowires directly on the polycarbonate film 10.

As described above, the nanowire-equipped film in this embodiment comprises a polycarbonate film (substrate) 10 made of an amorphous resin, and ZnO nanowires grown directly on the polycarbonate film 10, wherein the fine textured structure 10A having a pitch of 2 to 100 nm and a depth of 5 to 30 nm is formed on the surface of the polycarbonate film 10. Also, the grain boundary of the polycarbonate film is preferably deposited on the surface of the polycarbonate film 10. This allows the ZnO nanowires to be grown stably.

In this embodiment, ZnO nanowires can be grown directly on the polycarbonate film 10, which is made of an amorphous resin, which reduces the manufacturing cost. Also, since the ZnO nanowires do not contain any impurities caused by diffusion from a conventional seed layer, ZnO nanowires free of impurities can be peeled off and collected.

The ZnO nanowires in this embodiment can be manufactured by the steps shown in FIGS. 4A, 4B, 4C and 4D.

First, as shown in FIG. 4A, a polycarbonate film 10 made of an amorphous resin is prepared. The thickness of the polycarbonate film 10 is 50 to 500 μm, for example.

Next, as shown in FIG. 4B, the polycarbonate film 10 is surface-treated. This surface treatment is to be performed under conditions that will form a fine textured structure 10A on the surface of the polycarbonate film 10. The actual dimensions of the textured structure 10A are not shown in FIG. 4B. Here, the fine textured structure 10A is preferably formed such that the pitch is 2 to 100 nm and the depth is 5 to 30 nm.

Next, as shown in FIG. 4C, the polycarbonate film 10 is immersed in the hydrothermal synthesis solution 40 in the container 30 to grow ZnO nanowires directly on the polycarbonate film 10. Since the polycarbonate film 10 is extremely thin, it is preferable to immerse it in the hydrothermal synthesis solution 40 while fixed to the jig 50. More specifically, as shown in FIG. 5, the polycarbonate film 10 is pressed by pieces of slide glass 52, 52, these pieces of slide glass 52, 52 are sandwiched between glass plates 51, 51 and fixed, and this product is placed on a stainless steel plate 53 and immersed in the hydrothermal synthesis solution 40 in this state.

An aqueous solution containing a mixture of zinc nitrate (Zn(NO₃)₂/6H₂O) and hexamethylenetetramine (C₆H₁₂N₄) can be used for the hydrothermal synthesis solution 40, for example. The concentration of the hydrothermal synthesis solution 40, the mixing ratio, the temperature, the immersion time, and so forth may be suitably determined as dictated by the required specifications of the ZnO nanowires.

After the polycarbonate film 10 has been immersed in the hydrothermal synthesis solution 40 for a specific length of time, the polycarbonate film 10 on which the ZnO nanowires have grown is washed and dried to obtain a ZnO nanowire-equipped film 20 as shown in FIG. 4D.

The present disclosure was described above through a preferred embodiment, but what was said above is not intended to be limiting in nature, and various modifications are of course possible.

For example, in the above embodiment, the polycarbonate film 10 was used as the substrate, and ZnO nanowires were grown on this substrate, but this is not the only option, and any substrate made of an amorphous resin may be used. This amorphous resin can be a polystyrene, a cycloolefin, or the like, for example.

Also, in the above embodiment, the ZnO nanowires 20 were grown on the polycarbonate film 10, but this is not the only option, and nanowires made of some other metal oxide such as titanium oxide (TiO) can be grown instead.

1. A nanowire-equipped film, comprising:
a substrate made of a crystalline resin; and
nanowires made of a metal oxide and grown directly on the substrate,
a fine textured structure being formed on a surface of the substrate, and
the nanowires being grown directly from the textured structure.

2. The nanowire-equipped film according to claim 1, wherein
the textured structure has a size that is a micrometer or less and a depth that is on a nanometer level.

3. The nanowire-equipped film according to claim 1, wherein
the crystalline resin is made of a polyimide or a polyester.

4. A nanowire-equipped film, comprising:
a substrate made of an amorphous resin; and
nanowires made of a metal oxide and grown directly on the substrate,
a fine textured structure being formed on a surface of the substrate and having a pitch of 2 to 100 nm and a depth of 5 to 30 nm, and
the nanowires being grown directly from the textured structure.

5. The nanowire-equipped film according to claim 4, wherein
the amorphous resin is made of a polycarbonate or a polystyrene.

6. The nanowire-equipped film according to claim 1, wherein
the nanowires are made of zinc oxide or titanium oxide.

7. A method for manufacturing nanowires, comprising:
preparing a substrate made of a crystalline resin;
forming a fine textured structure on a surface of the substrate; and
immersing the substrate in a hydrothermal synthesis solution to grow nanowires made of a metal oxide directly on the textured structure formed on the surface of the substrate.

8. The method for manufacturing nanowires according to claim 7, wherein
the forming of the textured structure involves surface-treating the substrate.

9. The method for manufacturing nanowires according to claim 7, wherein
the forming of the textured structure involves forming the textured structure such that the textured structure has a size that is a micrometer or less and a depth that is on a nanometer level.

10. The method for manufacturing nanowires according to claim 7, wherein
the crystalline resin is made of a polyimide or a polyester.

11. The method for manufacturing nanowires according to claim 7, wherein
the nanowires are made of zinc oxide or titanium oxide.

12. A method for manufacturing nanowires, comprising:
preparing a substrate made of an amorphous resin;
forming a fine textured structure having a pitch of 2 to 100 nm and a depth of 5 to 30 nm on a surface of the substrate; and
immersing the substrate in a hydrothermal synthesis solution to grow nanowires made of a metal oxide directly on the textured structure formed on the surface of the substrate.

13. The method for manufacturing nanowires according to claim 12, wherein
the forming of the textured structure involves surface-treating the substrate.

14. The method for manufacturing nanowires according to claim 12, wherein
the amorphous resin is made of a polycarbonate, a polystyrene, or a cycloolefin.

15. The method for manufacturing nanowires according to claim 12, wherein
the nanowires are made of zinc oxide or titanium oxide.

16. The nanowire-equipped film according to claim 2, wherein
the crystalline resin is made of a polyimide or a polyester.

17. The nanowire-equipped film according to claim 2, wherein
the nanowires are made of zinc oxide or titanium oxide.

18. The nanowire-equipped film according to claim 3, wherein
the nanowires are made of zinc oxide or titanium oxide.

19. The nanowire-equipped film according to claim 4, wherein
the nanowires are made of zinc oxide or titanium oxide.

20. The nanowire-equipped film according to claim 5, wherein
the nanowires are made of zinc oxide or titanium oxide.
